(19) United States
(12) Patent Application Publication
(10) Pub. No.: US 2014/0056838 A1
(43) Pub. Date: Feb. 27, 2014

(54) Recreational Water with Improved Interaction with Skin, Hair and Eyes

(71) Applicant: Chemtura Corporation, Middlebury, CT (US)

(72) Inventors: Curt Sayre, Atlanta, GA (US); Robin Cantrell, Marietta, GA (US)

(73) Assignee: CHEMTURA CORPORATION, Middlebury, CT (US)

(21) Appl. No.: 13/959,902

(22) Filed: Aug. 6, 2013

Related U.S. Application Data
(60) Provisional application No. 61/692,437, filed on Aug. 23, 2012.

(51) Int. Cl. C02F 1/68

(52) U.S. Cl. CPC C02F 1/68
USPC 424/70.17; 424/78.02

(57) ABSTRACT

The feel of skin and hair and the manageability of hair exposed to recreational water is improved by the addition of select organic polymers, e.g., charged organic polymers such as cationic organic polymers containing multiple charges. In one embodiment, excellent results are achieved when the added organic polymer(s) include polymeric quaternary ammonium compounds such as poly-DADMAC. The cationic organic polymers of the invention do not interfere with the activity of other recreational water treatments such as halogen releasing compounds and do not decompose due to the presence of halogen releasing water sanitizers, generate a detectable odor or impart noticeable color to the recreational water.

This application claims benefit under 35 USC 119(e) of U.S. Provisional Application No. 61/692,437 filed Aug. 23, 2012, the disclosure of which is incorporated herein by reference.

Addition of select organic quaternary ammonium polymers to recreational water improves the feel of skin and hair of swimmers, hot tub users and the like that are exposed thereto.

### BACKGROUND OF THE INVENTION

Recreational water such as found in swimming pools, spas/hot tubs etc., provide a great deal of pleasure and comfort. The extent of comfort depends on the quality of the water. For example, the water is treated to be effectively free of pathogens and chemicals which may cause illness, to maintain the proper pH and be otherwise environmentally safe. In order to assure the comfort and safety of people who enter these waters, it is also important that the water be treated properly so that it is aesthetically pleasing in terms of, e.g., taste, color, turbidity, odor and the absence of algae etc.

Traditionally, a great deal of attention has been given to keeping the water clear and free from algae, bacteria and other organisms. For example, pool filters, skimmers, algaecides, flocculants, chemical dispensers such as those used with chlorinating tablets and the like are all familiar to anyone using a pool or spa.

However, many of the common chemical water treatments used to keep the water clean and free of organisms etc., can create a situation wherein the treated water has a negative impact on those entering the water. For example, many pool users have experienced, and in some cases may anticipate, symptoms such as burning eyes, dry tangled hair and dry feeling skin that can occur during or following exposure to pool or spa water. Formulators of course take these possible negative effects into account when preparing recreational water treatments and do their best to minimize such effects.

Despite the best efforts of formulators, many people still experience negative impacts of pool and spa water on their skin, hair and eyes. Finding a water treatment that neutralizes the negative effects of treated recreational water without interfering with the activity of the water maintenance formulations would be desirable. Even more desirable would be a water treatment that improves the way skin or hair feels after contact to recreational water relative to the feel prior to water contact. For example, it is well known by those skilled in the art that the addition of borates, alone or as part of a water treatment composition, such as a sanitizing composition, can make the water feel better for swimmers while in a pool, however borates are inadequate in improving the skin feel of the swimmer upon leaving the pool.

Many cosmetic products are known which contain compounds that smooth and moisturize the skin or make hair feel softer and be more manageable. Such compositions contain for example, emollients, surfactants, naturally occurring oils and the like. A wide range of cosmetic compositions containing these and other components active on skin and hair are widely known and widely used. In one example, U.S. Pat. No. 6,024,952 discloses washing formulations, soaps and conditioning shampoos, comprising a sparingly soluble complex of an anionic emollient with a polymeric quaternary ammonium salt, specifically POLYQUAT 6, a polyDADMAC polymer. It is postulated that combining the polyquat with the emollient creates a sparingly soluble complex, which, due to this limited solubility, is deposited on skin etc, and is difficult to remove. The deposition results in improved skin feel, including skin softness, skin moisture, skin hydration and skin smoothness. Skin appearance is approved as well. U.S. Pat. No. 6,024,952 reports that when used alone, POLYQUAT 6 fails to provide the benefits under the conditions tested.

Providing a composition that when added to pool and spa water would have a similar positive effect on skin and/or hair, faces many difficult challenges. For example, given the amount of water in a swimming pool, the compositions must be active at low doses in order to be economically feasible.

The composition has to be compatible with the water at effective concentrations without foaming, creating an unpleasant odor, causing undue color, forming emulsions, precipitating or otherwise separating from the water, etc. For example, the active complex of U.S. Pat. No. 6,024,952 is only sparingly soluble in water. The composition of course must not be toxic at use levels and be environmentally acceptable.

Furthermore, even if a composition with the desired properties can be found, the composition must be stable in the presence of other common water treatments and be easily handled and used. For example, many pools and spas are treated with halogen releasing compounds, e.g., chlorine sanitizers or algaecides etc, which create an oxidizing environment. Any water treatment added to improve the feel of skin or hair must therefore be stable in the presence of these oxidizers.

Quaternary ammonium compounds such as tetra-alkyl ammonium halides, trialkylammonium halides and the like have long been known to have biocidal activity. Polymeric quaternary ammonium compounds which contain many ammonium salt moieties in a single polymer compound are also known and have similar activity. U.S. Pat. No. 5,142,002 discloses polymeric quaternary ammonium compounds which act as algaecides in water at 0.1 to 10 ppm, and which compounds can be used in the presence of oxidizing agents such as peroxides, chlorinated oxidizers, monopersulfates and peroxydisulfates. U.S. Pat. No. 3,771,989 discloses that adding as little as 5 to 10 ppm of certain poly quaternary ammonium compounds, also called polyquats, can keep a pool free of algae growth. U.S. Pat. Nos. 5,783,092 and 5,882526 disclose poly-quat/peroxide water treatment compositions. U.S. Pat. Nos. 5,035,808; 4,746457; 5,171,350; 6,811,711; 5,527,506 and 5,753,181 all disclose compositions comprising a poly-quat and another active, e.g. biguanide, metal salt etc, which useful in protecting pool water from algae, bacteria etc.

However, there is no report regarding the effect on skin and hair of water containing these polyquats at the disclosed concentrations. Further, according to U.S. Pat. No. 6,024,952, polyquats are ineffective in improving skin feel when used without an anionic emollient.

US 2008/0011690 and 2012/0195979 disclose the addition of high molecular weight polyalkylene glycols to recreational water as a means for imparting emollient properties to the water. However, the use of these polymers requires some special handling as the polymers can take many hours to dissolve when added to pool water and create temporary flow rate problems with the pumps and filters used in pool sanitation. In preferred embodiments 60-80% by weight of sodium tetraborate is added to aid in dissolution of the polymer. Addition of blends comprising the polyalkylene glycols and other components are generically disclosed, including, for example, “quaternary ammonium compounds”, but no further identification of a useful species of quaternary ammonium compounds is given.

Despite the difficulties in identifying compounds useful for improving the impact of treated recreational water on the skin and/or hair of the bather, it has been found that certain select polyquaternary ammonium polymers when added to recreational water not only eliminate many of the potential negative effects of pool and spa water, particularly, pool and spa water treated with oxidizing sanitizers or algaecides, but also noticeably improves the skin feel, hair feel and even the manageability of the hair of a person exposed to the water so treated.

The benefits to skin and hair of the invention are realized without compromising human safety and environmental suitability of the water, and does not negatively impact any of the ascetically pleasing characteristics of the water or interfere with the activity of other water treatments. The select quaternary ammonium polymers are effective in the absence of other cosmetic adjuvants such as the anionic emollient of U.S. Pat. No. 6,024,952 or the polyalkylene glycol of US 2008/0011690, which have been shown to have deleterious side effects as described above.

### SUMMARY OF THE INVENTION

The present invention provides a method for treating recreational water to improve the feel of an individual's skin and/or hair while in the skin and/or hair is contact with the water, and also after contact with the water ends, the method comprising the addition of certain organic quaternary ammonium polymers, also referred to herein as polyquats, to the water and contacting the water with the individual's skin and/or hair. Certain poly DADMAC polymers have been found to be particularly useful polyquats. Recreational water includes, for example, water found in pools, hot tubs/spas and the like. Contact with the water occurs for example when an individual enters the water of the pool or spa, or when the individual immerses a portion of their body, such as feet, legs or arms into the pool or spa water, for example, by swimming, playing or otherwise relaxing in a pool, immersion in a spa, etc.

The polyDADMAC is often added to the recreational water prior contacting individual's skin or hair; it may also be added to a pool or spa which is already occupied by one or more persons.

In many embodiments of the invention, the select organic quaternary ammonium polymer is a polyDADMAC, that is a diallyl dimethylammonium chloride polymer. While one may assume that a variety of cosmetic agents known to improve the feel or manageability of skin and hair may be useful in the present method, for example, surfactants known to reduce water tension and adhere to skin or hair, such as, fluorosurfactants, ethoxylated alcohols etc, glycols, anionic surfactants, cationic surfactants such as poly quats, skin emollients and the like, it has been found that many such materials are not suitable for a variety of reasons. Consistently good results regarding skin feel and/hair feel or manageability are not obtained with all of these materials at the desirably low concentrations, and some produce problems such as foaming, discoloration, odor etc., or are unstable in oxidizing conditions.

Typically, the water being treated according to the invention already contains other common pool or spa additives, including oxidizing compounds such as peroxides and halogen releasing compounds such as calcium hypochlorite and trichloroisocyanurate. The present invention includes embodiments wherein the water being treated with the select polyquat has been treated or will be treated with an oxidizing compound, or, wherein the water is treated with the polyquat of the invention simultaneously with an oxidizing compound.

### DESCRIPTION OF THE INVENTION

The invention provides a process wherein a select organic quaternary ammonium polymer is added to recreational water, e.g., pool or spa water, in an amount effective to improve the feel or comfort of skin and/or hair of persons while i) they are in contact with the water and ii) after their skin hair and/or eyes are no longer in contact the water. Typically the organic quaternary ammonium polymer is a polyquat having a high cationic charge per MW, for example a polyDAMAC polymer, i.e., a homopolymer or copolymer comprising monomer units:

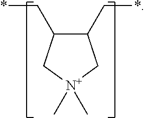

The polyDAMAC polymer of the invention, typically a DADMAC homopolymer, has a weight average molecular weight of from about 1,000 to about 1,000,000, for example, from about 1,000 to about 750,000 or from about 1,000 to 100,000, such as from about 1,000 to about 75,000. Higher molecular weight polyDADMACs may create difficulties when being added to a pool or spa, and lower molecular weight polyDADMACs may not be sufficiently effective at improving skin feel or hair manageability. Many grades of PolyDADMAC polymers are commercially available.

The recreational water may contain any of the common water treatment additives, and in many embodiments the pool or spa water to which the organic polymer of the invention is added is treated with an oxidizing material, e.g., a peroxide or halogen releasing compound, either before, after, or at the same time as the organic polymer of the invention.

Adding the polymer of the invention at “an amount effective to improve the feel or comfort of skin and or hair” means adding the polymer of the invention to the water at a concentration which results in the water having a noticeably improved interaction with skin and/or hair, and often less eye discomfort, compared with water not treated according to the invention, both during contact with the water and after the individual ends contact with the water and dries off. In many embodiments hair manageability is also improved. In many embodiments, skin feel and hair feel etc, are improved after exposure to the water treated according to the invention over the way the skin or hair felt before exposure.

For a number of reasons, including possible toxicity, negative impact on aesthetics of the recreational water, and cost, the select organic quaternary ammonium polymer active polymer of the invention should be effective at low concentrations. The polyquat of the invention, e.g., polyDADMAC, has shown excellent activity in swimming pool water at concentrations of less than 200 ppm, e.g., 150 ppm and typically less than 100 ppm. Good effects have been observed at concentrations such as 75 ppm or less, or 60 ppm or less, and in some embodiments 45 or 40 ppm or less. Typically, to produce a positive effect the concentration should be greater than 15 ppm, for example 20 ppm or more, or 25 ppm or more. In general, positive effects are consistently attained at levels of from about 20 to 60 ppm of the polyquat. Larger amounts of polyquat can be used, but the additional effects of adding more are often less dramatic, and less cost effective, at levels above 100 ppm.

Of course the economic costs of adding the polyquat to a spa are less of an issue than when adding the polyquat to a much larger swimming pool. So, while treatment levels of a swimming pool are often less than 100 ppm of the polyquat, larger amounts may be found in spas, and continued improvements in the feel of the water have been found in spas when dosed at levels of 200, 300 and 400 ppm.

One embodiment of the invention provides a method wherein a polyDADMAC polymer, e.g., a DADMAC homopolymer having a molecular weight of at least 1,000 but no more than 1,000,000, is added to recreational water at a concentration of from about 15 ppm to about 200 ppm, e.g. about 15 ppm to about 100 ppm. In another embodiment, the polyDADMAC is added at a level of from about 200 to about 400 ppm to recreational water, particularly water in a spa.

To be effective in the present invention, the skin and hair active component must improve the feel of skin and hair, but at a minimum must also be compatible with, and stable in, pool and spa water systems that contain halogens peroxides or other potential oxidizers. They should be easily handled, and be safe to skin and eye contact in use. Surprisingly, polyDADMACs of the invention meet all these requirements where other materials known to have positive effects on skin and hair treatment in cosmetic compositions, including certain ammonium compounds, failed.

That is, the polyquats of the invention were found to far more effective in attaining the goals of the invention than a variety of other cosmetic adjuvants, for example, “skin softeners” and emollients, such as glycerine and alkoxylated esters including alkoxylated diesters, such as alkoxlyated adipates, and alkoxylated fatty acid esters, such as alkoxulated cocoates; surfactants including fluorosurfactants and glycol ethers such as non-ionic ethoxylated alcohols; and many other cationic polymers including a selection of polyquats. Many such materials, when used according to the invention at practical dose levels, were ineffective at improving skin feel, many were unstable under conditions typically found in swimming pools and spas, e.g., in the presence of halogen oxidants, and some had unappealing aesthetic characteristics that made them unacceptable for use in pools and spas.

Initial screening test for possible skin and hair active components for use in the invention involved a test person inserting for several minutes an arm into water containing 3 ppm of chlorine as sanitizer and up to 100 ppm test compound. When removed from the water the arm was washed and dried, and then reinserted into water containing 3 ppm of chlorine as sanitizer and up to 100 ppm of another test compound. Each test compound was rated for the effect it had on skin feel while the arm was inserted and after the arm was removed.

In subsequent tests, the test compound was added to the pool water well before the test person's arm was inserted to see whether the test compound was stable to chlorine induced degradation.

Many of the surfactants and skin emollients failed to produce any discernible effect on skin feel at 100 ppm concentrations.

Many of these materials also proved to be unstable under oxidizing conditions, negatively impacted the aesthetics of the water, and/or were not readily handled or administered. Many of the skin emollients and surfactants tested demonstrated handling problems such as foaming and insolubility. Aside from being unappealing ascetically, lack of water compatibility may correlate with certain sensory failures. For example, various skin emollients are not compatible with pool water systems and cause extreme turbidity to the water, and many of these emollients also left a slimy feel during skin sensory testing.

Some of the surfactants did improve the skin feel while the arm was immersed, but had no effect on skin feel once the arm was removed.

It was noted however that several polymeric quaternary ammonium compounds provided improvement in skin feel both during contact with the water and after the test arm was removed from the water, whereas the other test compounds failed. The active polyquats included for example, compounds such as such as polyquat Q6/6 (polymer made from the reaction between N,N,N′,N′-tetramethyl-1,6-diaminohexane and 1,6-dichlorohexane), PHMB (polyhexamethylene biguanide hydrochloride) polyDADMAC polymers (diallyldimethyl ammonium chloride polymers), WSCP (poly[oxyethylene-(dimethylimino) ethylene-(dimethylimino) ethylene dichloride]); and the like.

It is known that reducing surface tension of water can improve skin feel, while one's skin is in contact with the water. However, as discussed in U.S. Pat. No. 6,024,952, cited above, in order to impart a benefit to skin and/or hair, the active component must stay in contact with the skin or hair after the contact with the treated water ends. That is, while the water treatment of the invention must be soluble in the recreational water, it must also have enough attraction to skin and/or hair to stay attached thereto after the person contacting the treated water leaves the water and towels off.

While not wanting to be bound by theory, it was surmised that increased cationic charge density of the active polyquats may drive the equilibrium between dissolved compound and skin associated compound toward skin association, especially when the charge relative to MW was high.

The compounds responsible for improving skin and hair feel must also be stable in an oxidizing environment as oxidants such as halogen sanitizers are frequently used in swimming pools and spas. Many compounds tested failed, e.g., glycols and amino or imino polymers, appeared to be unstable in the presence of chlorine and, for example, certain imino polymers degraded to generate an unpleasant odor.

Some of the polyquats that were found to be effective at improving skin feel after immersion at desirably low concentrations, e.g., 25 ppm to 100 ppm also demonstrated inadequate chlorine stability or poor aesthetic characteristics. For example, Polyquat Q6/6 and PHMB did not have the desired stability in the certain oxidizing pool environments. Upon standing, the water containing these compounds and 3 ppm chlorine developed an odor presumably due to breakdown of the polyquat. WSCP was relatively stable in the presence of chlorine or bromine, however, the material as provided is a dark brown/tarry substance, is difficult for the pool owner to handle, and ascetically unappealing.

However, the DADMAC polymers of the invention did exhibit the desired skin and hair activity, proved to be stable to the added chlorine, and were completely acceptable in terms of aesthetic characteristics when added to the water.

Poly-DADMACS are known in cosmetic and hair care applications, but suppliers recommend that it be present in at least 0.75% of the formulation, i.e., 7500 ppm. In the present method, it is found that less than 100 ppm of polyDADMAC in pool and spa water can provide excellent activity skin and hair activity.

Cationic polymers such as polyquats are also known to be effective in controlling algae at concentrations of about 10 ppm. However, at these concentrations no discernible effect on skin feel was noted.

The polyquat can be added to the pool or spa water neat or as part of a formulation or solution. For example, a formulation may contain the polyquat and a buffer, dye, and/or fragrance and may also contain other components. The water being treated according to the invention may contain other water treatments, and typically does contain standard pool and spa treatments, e.g., clarifiers, sanitizers, acid sources, alkalinity sources, biocides including algaecides and bactericides, pH controllers such as buffers, other amine salts, oxidizing agents such as sources of bromine or chlorine or peroxides, flocculants etc. Any manner of addition to the water is permissible under the present invention.

One particular embodiment of the invention provides a method for treating recreational water to provide improved skin feel, hair feel, and/or hair manageability, which method comprises adding to said recreational water, e.g., pool or spa water, at least one poly quaternary ammonium compound, typically a poly-DADMAC polymer, at an amount effective to improve the feel or comfort of skin, hair, and/or eyes during and following contact with the pool or spa water.

In one embodiment, polyDADMAC with a weight average MW of from about 1,000 to about 1,000,000 is added to recreational water at a concentration of from about 20 ppm to about 200 ppm based on the amount of water. In another embodiment, the polyDADMAC is added to recreational water at a concentration of from about 200 ppm to about 400 ppm.

The polyDADMAC with a weight average MW of from about 1,000 to about 1,000,000 may have for example, a MW of from about 1,000 to about 750,000, from about 1,000 to 100,000, for example from about 1,000 to about 75,000, and is typically a DADMAC homopolymer.

When added to recreational water at a concentration of from about 15 ppm to about 200 ppm based on the amount of water, the poly-DADMAC is added, for example, at a concentration of from about 20 ppm to about 150 ppm, from about 20 ppm to about 100 ppm, from about 20 ppm to about 75 ppm, from about 20 ppm to about 60 ppm, from about 20 ppm to about 50 ppm, from about 20 ppm to about 45 ppm, from about 25 ppm to about 60 ppm, from about 25 ppm to about 50 ppm or from about 25 ppm to about 45 ppm, or from about 25 ppm to about 40 ppm.

When added to recreational water at a concentration of from about 200 ppm to about 400 ppm based on the amount of water, the poly-DADMAC is added, for example, at a concentration of from about 250 ppm to about 400 ppm, from about 300 ppm to about 400 ppm.

The recreational water treated by the invention is also often treated with oxidizing agents such as chlorine, bromine and peroxide sources. In many embodiments, the polyDADMAC of the invention is added to water which has been treated with such an oxidizer, very often a halogen oxidizer such as a source of chlorine or bromine. In other embodiments the polyDADMAC is added before the water is so treated and in some embodiments the polyDADMAC and peroxide or halogen are added at the same time.

The invention thus provides an improved method for treating recreational water, which water is treated with an oxidizing agent, for example water that is treated with at least a halogen releasing compound, the improvement being the further addition to the water, or presence in the water, of a polyDADMAC polymer at an amount effective to improve the feel or comfort of skin and/or hair while in contact with the water and also after the skin and/or hair are no longer in contact the water. The concentration of the oxidizing agent is any amount typically encountered in the treatment of swimming pool or spa water.

The poly-DADMAC of the invention is stable to the presence of oxidizers such as chlorine and bromine, however, as is common with many pool and spa water treatments, the polyquat of the present invention is depleted over time. Tests have shown the rate of depletion to be independent of halogen content. Embodiments of the invention also provide for maintenance dosing of the water after the initial dose is advised, that is, addition of additional polyDADMAC to the water at various times to reestablish an effective concentration of the polymer. For example, the invention further provides a method whereby additional cationic polymer, typically at a smaller amount than the original dose, is added at intervals, e.g., at intervals of from 1 to 60 days, e.g., weekly or monthly intervals, to re-establish the desired concentration of cationic polymer.

The polyDADMAC of the invention is commercially available or made using known methods. The poly-DADMAC may be added to the water along with other active components and more than one skin or hair active component may be used, although this is certainly not necessary. Thus, one embodiment of the invention provides a method for treating water wherein a polyDADMAC polymer is added to the water, which water is also treated with a chlorine of bromine source, with the proviso that the poly-DADMAC is part of a composition wherein no anionic surfactant, nonionic surfactant or anionic or non-ionic skin emollient is present. In some particular embodiments such surfactants and emollients are absent from the water being treated.

The addition to water of the poly-quat of the invention, e.g., poly-DADMAC, can be by any convenient means. The polymer can be added by itself or as part of a multi-component composition. Other components may also be included in a composition containing the polymers of the invention to improve the handling of the composition, to make the composition more effective, or to provide other desired effects for the water. For example, an aqueous solution of the polyDADMAC may be added to the water.

For example, a formulation may contain the polyquat and a buffer, dye, and/or fragrance and may also contain other components. The water being treated according to the invention may contain other water treatments, and typically does contain standard pool and spa treatments, e.g., clarifiers, sanitizers, acid sources, alkalinity sources, biocides including algaecides and bactericides, pH controllers such as buffers, other amine salts, oxidizing agents such as sources of bromine or chlorine or peroxides, flocculants etc. Any manner of addition to the water is permissible under the present invention.

The poly-DADMAC of the invention is often commercially available as a solution in water, typically at 5, 20 or 40% by weight in water. In the following exemplary formulation according to the invention, the Poly-DADMAC polymer is the homopolymer “POLYQUATERNIUM 6” having a weight average MW of between 5,000 and 50,000, which is added to the formulation as part of a 40% solution:

| | | |
|---|---|---|
| Poly-DADMAC-polyquaternium 6 | 85-98 | wt % |
| Medium MW, 40% in water | | |
| Water | 2-7 | wt % |
| Sodium bisulfate | 0.01-0.5 | wt % |
| Fragrance | 0.0-0.5 | wt % |
| Sodium carbonate | 0.01-0.5 | wt % |
| Dye | 0.0-0.01 | wt % |

For example, one particular formulation useful in testing:

| | | |
|---|---|---|
| Poly-DADMAC-polyquaternium 6 | 95 | wt % |
| Medium MW, 40% in water | | |
| Water | 4.9 | wt % |
| Sodium bisulfate | 0.05 | wt % |
| Fragrance | 0.01 | wt % |
| Sodium carbonate | 0.35 | wt % |
| Dye | 0.001 | wt % |

Of course, variants of the above formulations are immediately obvious to one skilled in the art.

It is quite surprising that the use of a relatively low concentration of a single component introduced into recreational water could produce such a consistent and profound effect. For example, wide spread field testing of the invention has consistently generated positive reports relating to the feel of a swimmers skin and hair, as well as reports of more comb-able hair, after swimming in a typical pool containing the poly-DADMAC and standard additives including the usual halogenated compounds.

### EXAMPLES

### Example 1

A series of 8 gallon aquaria were filled with pool water containing chlorine at about 3 ppm as sanitizer. Test materials were added at 100 ppm. Test materials included:

I) Glycerine,

II) PEG glycerol adipate,

III) Alkoxylated fatty acid ester,

IV) Fluorosurfactant,

V) Non-ionic ethoxylated alcohol,

VI) POLYQUAT Q6/6 (linear polyquaternery ammonium polymer),

VII) PHMB (polyhexamethylene biguanide hydrochloride),

VIII) Poly-DADMAC (diallyldimethyl ammonium chloride polymer),

IX) WSCP (poly[oxyethylene-(dimethylimino) ethylene-(dimethylimino) ethylene dichloride])

Twenty test persons inserted an arm into the water of one aquarium for several minutes, the arm was washed and dried. Each person tested several different formulations. The water in each aquarium was then ranked on how their skin felt upon removal and how the water felt while their arm was immersed.

POLYQUAT Q6/6, PHMB, Poly-DADMAC, and WSCP were found to be the most consistently active materials in improving skin feel both the arm was inserted the water and after the arm was removed from the water and dried.

Test materials I, II, III, IV and V provided no benefit when the arm was removed from the water and dried. Materials II, III and IV provided undetectable or barely detectable improvement during while the arm was immersed and materials II and III tended to leave the skin with a slightly slimy feel when removed from the water.

### Example 2

The test compounds were added to the pool water as in Example 1 and then held for at least 24 hours before observations were recorded regarding aesthetic qualities of the test waters. Foaming was noted for test materials II, III and IV; turbidity was noted for materials II and III.

Decomposition was noted for glycerin, Polyquat Q6/6 and PHMB. Polyquat Q6/6 and PHMB developed an odor upon standing in the chlorinated water. WSCP is a dark brown tarry substance and is difficult to add to the water. No negative characteristics were noted for polyDADMAC.

### Example 3

A series of aquaria were filled with pool water containing chlorine at about 3 ppm as sanitizer as above. Polyquat 6 was added to the water at levels ranging between 10 and 100 ppm and tested for improvement of skin feel as in Example 1. Consistently high sensory detection was reported at levels of 25 ppm and higher and effects were noted at 20 ppm. Below 15 ppm no effect was observed.

### Example 4

Test pools and spas were dosed at 35 ppm with Polyquat 6. Swimmers swam in the pools to test the effects on eyes, skin and hair. There were no adverse affects noted and sensory detection improving skin and hair feel were noted in both the pool and spa.

### Example 5

A 40 ppm dose of the poly-DADMAC, POLYQUATERNIUM 6 was added to an outdoor swimming pool. The water was measured daily to determine the remaining concentration of the poly DADMAC. The concentration of the DADMAC polymer was 20 ppm after 7 days, and after 20 day the concentration had dropped to 10 ppm.

The above test was repeated using outdoor swimming pools containing different levels of chlorine sanitizer and the water was measured daily for remaining concentration of the poly DADMAC. The loss of poly-DADMAC did not significantly vary with changes in chlorine level indicating the polymer loss was not due to chlorine instability but other factors.

### Example 6

Formulations containing the poly-DADMAC similar to those above were then used to dose 31 pools across New Mexico, Illinois and Georgia at 40 ppm poly-DADMAC for field trials. After several months of testing there have been no adverse reports and many reports of positive feedback.

### Example 7

An approximately 40% by weight aqueous solution of Polyquaternium 6 containing less than 1% of sodium bisulfate, fragrance, sodium carbonate and dye was provided to test participants to test dose response relative to perceived performance. 116 participants completed all aspects of the test. The participants were divided into 2 dosage categories: ˜40 ppm & ˜25 ppm. Respondents rated performance on a scale of 1 through 10, 10 being extremely satisfied.

The bulk of the repsondents were generally satisfied with the performance at either dose level, the majority being very or extremely staisfied. Most respondents rated the specific performance relative “tangle free hair”, “itch free skin” and “soft water” as good to excellent at either dose level. The performance relative to tangle free hair was slightly higher for the 40 ppm dose; performance relative to soft water hair was slightly higher for the 25 ppm dose, but the diifference in these ratings were minimal.

1. A method for improving the feel of skin and/or hair while in contact with, and upon exiting, recreational water, the method comprising adding to the recreational water a select organic quaternary ammonium polymer in an amount effective to improve the feel or comfort of skin, and/or hair while in contact with the water, and also after the skin and/or hair are no longer in contact the water.

2. The method according to claim 1 wherein the select organic quaternary ammonium polymer comprises one or more homopolymer or copolymer having a weight average MW of from about 1,000 to about 1,000,000 and comprising monomer units:

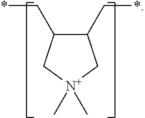

3. The method according to claim 2 wherein the select organic quaternary ammonium polymer comprises one or more diallyldimethyl ammonium chloride homo-polymer having a weight average MW of from about 1,000 to about 100,000.

4. The method according to claim 3 wherein one or more diallyldimethyl ammonium chloride homo-polymer is added to the recreational water at a concentration of from about 15 to about 400 ppm.

5. The method according to claim 4 wherein the recreational water is also treated with a source of chlorine or bromine.

6. The method according to claim 1 wherein the select organic quaternary ammonium polymer, does not interfere with the activity of other recreational water treatments, and does not decompose due to the presence of halogen releasing water sanitizers, generate a detectable odor or impart noticeable color to the recreational water.

7. The method according to claim 5 wherein the one or more diallyldimethyl ammonium chloride homo-polymer is added to the recreational water at a concentration of from about 15 ppm to about 200 ppm.

8. The method according to claim 7 wherein the one or more diallyldimethyl ammonium chloride homo-polymer is added to the recreational water at a concentration of from about 20 ppm to about 100 ppm.

9. The method according to claim 5 wherein the one or more diallyldimethyl ammonium chloride homo-polymer is added to the recreational water at a concentration of from about 200 ppm to about 400 ppm.

10. The method according to claim 4 wherein the one or more diallyldimethyl ammonium chloride homo-polymer is added to the recreational water at a concentration of 25 ppm or more but 150 ppm or less.

11. The method according to claim 5 wherein the one or more diallyldimethyl ammonium chloride homo-polymer is added to the recreational water at a concentration of 25 ppm or more but 150 ppm or less.

12. An improved method for treating recreational water, which recreational water is treated with at least a halogen releasing compound, the improvement being further addition to the recreational water, or presence in the recreational water of, one or more diallyldimethyl ammonium chloride polymer having a weight average MW of from about 1,000 to about 1,000,000 at an amount effective to improve the feel or comfort of skin or hair while in contact with the water and also after the skin hair and/or eyes are no longer in contact the water.

13. The method according to claim 12 wherein the one or more diallyldimethyl ammonium chloride polymer is a homo-polymer having a weight average MW of from about 1,000 to about 100,000.

14. The method according to claim 12 wherein the charged organic polymer is added to a concentration of from about 15 ppm to about 400 ppm.

15. The method according to claim 14 wherein the charged organic polymer is added to a concentration of from about 15 ppm to about 200 ppm.

16. The method according to claim 15 wherein the charged organic polymer is added to a concentration of from about 20 ppm to about 100 ppm.

17. The method according to claim 14 wherein the charged organic polymer is added to a concentration of from about 200 ppm to about 400 ppm.

18. The method according to claim 13 wherein the one or more diallyldimethyl ammonium chloride homo-polymer is added at a concentration of 25 ppm or more but 150 ppm or less.
